(19) United States
(12) Patent Application Publication
(10) Pub. No.: US 2003/0221030 A1
(43) Pub. Date: Nov. 27, 2003

(54) Access control bus system

(76) Inventors: Timothy A. Pontius, Crystal Lake, IL (US); Rune Hartung Jensen, San Francisco, CA (US); Thorwald Rebeler, Sunnyvale, CA (US)

Correspondence Address: Corporate Patent Counsel, U.S Philips Corporation, 580 White Plains Road, Tarrytown, NY, 10591, US

(21) Appl. No.: 10/155,265

(22) Filed: May 24, 2002

(51) Int. Cl. G06F 13/00

(52) U.S. Cl. 710/107

(57) ABSTRACT

An access control device inhibits data transfers on a bus between unauthorized initiator-target pairs. A permission-matrix is maintained that identifies the access permission of each initiator relative to each target. The access device monitors the bus and determines the identification of the initiator and the intended target. If the initiator has the appropriate access rights to the target, the bus communication is permitted to occur, otherwise the communication is blocked, and an error signal is asserted. To provide further security, the identifier of initiators that are local to the access control device are communicated to the access control device via a direct wired connection to each initiator.

### BACKGROUND OF THE INVENTION

1. Field of the Invention

This invention relates to the field of electronic systems, and in particular to an architecture for selectively controlling access to devices within an electronic system.

2. Description of Related Art

Electronic systems generally employ a bus structure for communicating data among components within the system. As used herein, a bus is a collection of signals used to provide a path to and from devices connected to the bus, and includes serial buses, parallel buses, and combinations thereof. As is known in the art, the use of a common bus structure often allows for more efficient use of design and development resources. Functional blocks that communicate via the bus can be designed independently, needing only to comply with the protocol established for the bus, rather than complying with myriad requirements of each of the other functional blocks within the system. Further efficiency is gained because these independently designed functional blocks may be suitable for use in other system configurations and applications, thereby distributing the development cost for such reusable blocks over a larger product base. The advantages of a bus architecture and modular design are realized regardless of whether the bus is a local bus within an integrated circuit, a bus on a printed-circuit “mother-board”, a bus on a backplane of a component rack, a serial-bus in a daisy-chained string of components, and so on.

An initiator of a data transfer operation in a bus environment typically asserts a data transfer instruction onto the bus. This instruction identifies a target device, to which the instruction is addressed. Each component monitors the bus to determine whether it is the target device; if a particular component is the target device, it responds to the data transfer instruction, otherwise, it remains quiescent. For example, a central processing unit (CPU) may assert a read command to a system bus, specifying a particular target memory address that contains the data that is intended to be read. A subset of this target memory address will generally correspond to a particular ROM or RAM component whose address range includes the target memory address, thereby signaling the particular ROM or RAM component as the target device. The targeted ROM or RAM component responds to this read request by asserting the value of the data at the target memory address onto the bus. In a more complex data transfer operation, the data transfer instruction may initiate a dialog between the initiator and the target before the actual data transfer occurs.

In many systems and applications, restrictions are placed on some or all data transfers. For example, in a media processing system, a user-identification device may be the only device that is permitted to access a permission-register of a video controller. In this example, the video controller is configured to permit or deny access to select content material based on the state of the permission-register. In a conventional processing system, such access control is provided by identifying the initiator in the data transfer instruction, or in the subsequent pre-transfer dialog, and structuring target devices to restrict access to select initiator identifications. Depending upon the degree of security required, the access control may include the use of password identification. For example, when the above example media processing system is first configured, the user-identification device and the video controller may effect a conventional secure key-exchange process, and thereafter use this securely-exchanged key to verify the identification of the data transfer initiator. In other environments, where security is not a concern, the access control may merely be via an agreed upon convention, or via a precautionary warning in a design document. Consider, for example, a media processing system within a DVD player that provides for parental control based on user-identification. In such a system, the likelihood of a hacker attacking the access control of the DVD player to subvert the parental control may be deemed to be slight, compared to the likelihood of a hacker attacking an access controller of a cable or satellite converter to obtain unlimited free movies. In this example, the DVD player may merely be designed with the assumption, or understanding, that only the user-identification device is configured to access the permission-register.

Such access control techniques, however, are vulnerable to subversion by hackers and viruses, or, depending upon the level of security provided, if any, to inappropriate access via accidental programming errors. Generally, the access control system is subverted by falsifying the initiator identification, thereby gaining access rights that are intended to be reserved for the falsely identified initiator. As noted above, such subversion may be avoided by incorporating sophisticated cryptographic verification techniques, but the costs of such avoidance measures often substantially exceed the benefits realized.

### BRIEF SUMMARY OF THE INVENTION

It is an object of this invention to provide an access control method, device, and architecture that reliably enforce access rights to components within an electronic system. It is a further object of this invention to provide an access control architecture that does not require access control enforcement in each target device. It is a further object of this invention to provide secure access control without requiring the use of cryptographic techniques. It is a further object of this invention to provide programmable access control within an electronic system.

These objects and others are achieved by providing an access control device that inhibits data transfers on a bus between unauthorized initiator-target pairs. A permission-matrix is maintained that identifies the access permission of each initiator relative to each target. The access device monitors the bus and determines the identification of the initiator and the intended target. If the initiator has the appropriate access rights to the target, the bus communication is permitted to occur, otherwise the communication is blocked, and an error signal is asserted. To provide further security, the identifier of initiators that are local to the access control device are communicated to the access control device via a direct wired connection to each initiator.

### BRIEF DESCRIPTION OF THE DRAWINGS

The invention is explained in further detail, and by way of example, with reference to the accompanying drawings wherein:

FIG. 1 illustrates an example block diagram of a bus system with access control in accordance with this invention.

FIG. 2 illustrates an example access control matrix in accordance with this invention.

FIG. 3 illustrates an example block diagram of an alternative bus system with access control in accordance with this invention.

Throughout the drawings, the same reference numerals indicate similar or corresponding features or functions.

### DETAILED DESCRIPTION OF THE INVENTION

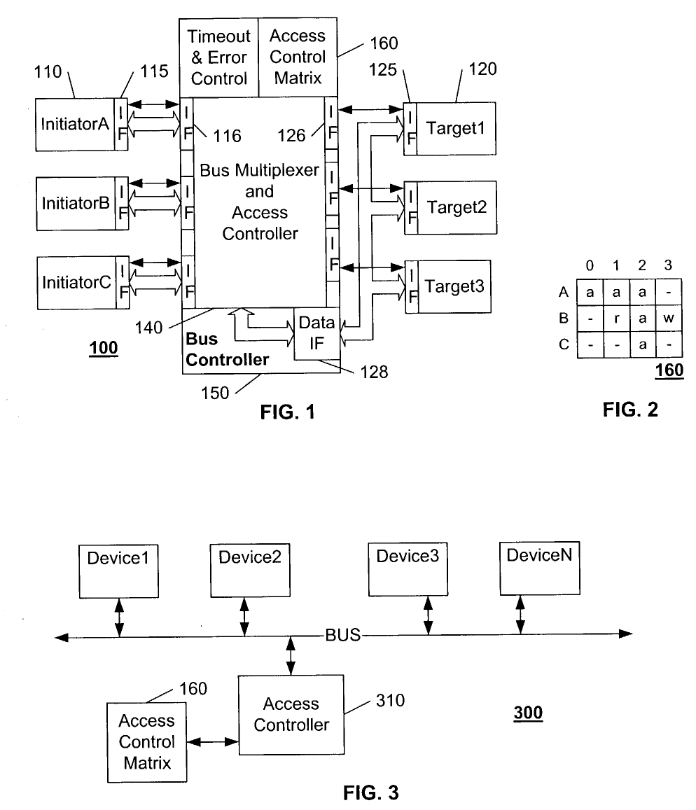

FIG. 1 illustrates an example block diagram of a bus system 100 with access control in accordance with this invention. The system 100 includes a plurality of functional components that communicate with each other via a common bus structure. For ease of understanding, the invention is presented using the paradigm of an initiator 110 of a bus transaction, and a target 120 of the communications with the initiator 110. A functional component may be an initiator 110 or a target 120, or may be both an initiator 110 and a target 120. A memory component, for example, is typically only a target 120, because a memory component does not generally initiate data transfers. In like manner, different regions of a memory space may each constitute a target 120. A CPU in a single processor system, on the other hand is typically an initiator 110, because it generally determines what communications will take place. If, however, the CPU allows interrupts via the bus structure, it will be a target 120 for the initiator of the interrupt. Note that, using this paradigm, the role as initiator 110 and target 120 is independent of the desired direction (read/write, transmit/receive) of data transfer.

Also for ease of understanding, the invention is presented using a centralized bus controller 150 that manages bus activities, including bus multiplexing and access control, timeout and error control, and so on. As will be evident to one of ordinary skill in the art, and discussed further below with regard to FIG. 3, the principles of this invention are applicable to bus structures with distributed bus control, wherein, for example, the arbitration and multiplexing functions are achieved by having each component cooperate to minimize bus contention.

Bus architectures include both “broadcast” buses and “directed” buses. In a broadcast bus, multiple components are commonly connected directly to the bus, so that the data that is presented to the bus is available to each of the components. In a directed bus, the interface to the bus is via a multiplexer that selects which devices are connected to the bus at a given point in time. The example system 100 of FIG. 1 illustrates a bus structure that includes a directed bus for communications with the initiators 110, and a broadcast bus for bus communications with the targets 120, to illustrate that the principles of this invention are applicable to directed buses, broadcast buses, or a combination of each.

Each of the components 110, 120 of the system 100 includes an interface adapter 115, 125, respectively, for communicating via the bus. The communications via the bus include data, which is indicated by the wide arrow symbols, and control signals, which are indicated by single width arrow symbols. In the directed bus structure used by the initiators 110, each interface adapter 115 has a corresponding interface module 116 at the bus controller 150. Both data and control signals are communicated between the interfaces 115, 116. In the broadcast bus structure used by the targets 120, each interface adapter 125 has a corresponding control interface module 126 for the control signals, but a data interface module 128 provides a common interface for data communications with all of the targets 120.

Copending U.S. patent application, “CONFIGURABLE SYNCHRONOUS OR ASYNCHRONOUS BUS INTERFACE”, Ser. No. 10/052,276 filed Jan. 17, 2002 for Pontius et al. discloses a bus control architecture that allows for both synchronous and asynchronous communications between each of the initiators 110 or targets 120 and the bus controller 150, thereby allowing for synchronous or asynchronous communications between the initiators 110 and targets 120, and is incorporated by reference herein.

In accordance with this invention, the bus controller 150 includes an identification of access rights among initiators 110 and targets 120. For convenience and ease of understanding, this identification of access rights is presented herein using the paradigm of an access control matrix 160 that is used to control the transfer of data between each initiator 110 and each target 120. One of ordinary skill in the art will recognize that alternative forms of representing access rights may be used, such as lists, rules, and so on, but regardless of the form or format of the access control information, each representation functionally corresponds to matrix that maps the right of each initiator to access each target. For example, to reduce storage requirements, the access control information may be stored as a list of prohibited accesses only, the implication being that each initiator-target pair that is not included in the list is a permitted access. As used herein, the term matrix corresponds to any form of data representation that can be mapped to a conventional matrix form.

FIG. 2 illustrates an example access control matrix 160 in accordance with this invention. The rows labeled A, B, and C in this example matrix 160 correspond to the initiators, InitiatorA, InitiatorB, and InitiatorC of FIG. 1, respectively. The columns labeled 1, 2, and 3 correspond to the targets, Target1, Target2, and Target3 of FIG. 1, respectively. In this example matrix 160, an “a” indicates that all access rights are granted, an “r” indicates that read-only access rights are granted, a “w” indicates that write-only access rights are granted, and a “-” indicates that no access rights are granted. In a simpler embodiment, the access rights may include only a binary “yes” or “no”, independent of the direction of data transfer; or, all initiators may have read rights to all devices, and the access rights may merely limit the right to write data to select targets. These alternatives, and others, will be evident to one of ordinary skill in the art in view of this disclosure. For example, in a more complex embodiment, the access control matrix may include an indication of capabilities, as well as rights, such as initiator-target pairs that can effect block-data transfers, and so on.

In accordance with another aspect of this invention, the access control matrix 160 is preferably programmable, to allow for the creation and modification of access rights as initiators 110 or targets 120 are added or removed from the system 100. To control the access to the access control matrix 160, the access control matrix includes the column labeled “0”, which, in this example, corresponds to the bus controller 150, and specifically the access control matrix 160.

As illustrated in the example matrix 160 of FIG. 2, InitiatorB is the only device that is permitted to access Target3, and this access is limited to writing data to Target3, as indicated by the “w” at the intersection of row B and column 3. InitiatorB may correspond, for example, to the example user-identification device, and Target3 may correspond to the permission-register of the example video-controller, as presented in the “Background of the Invention”, above.

As discussed above, the bus controller 150 of FIG. 1 is configured to receive data transfer requests from each initiator 110, and to selectively enable the target 120 of this data transfer request, based on the access rights indicated by the access control matrix 160. Using the example matrix 160 of FIG. 2, if InitiatorA or InitiatorC submits a data transfer request to Target3, the bus controller 150 will reject the request, and will not enable Target3 to effect the requested transfer, based on the “-” (no-rights) entry in column “3” of the access control matrix 160. In like manner, if InitiatorB requests a data transfer from Target3 to InitiatorB (i.e. a “read” request), the controller 150 will reject the request. If, on the other hand, InitiatorB requests a data transfer from InitiatorB to Target3 (i.e. a “write” request), the controller 150 will enable Target3 to receive the data, based on the “w” (write-only) entry in the access control matrix 160.

In like manner, based on the example access control matrix 160 of FIG. 2, the bus controller 150 of FIG. 1 will allow InitiatorA to read or write to the access control matrix 160, corresponding to the “a” (all-rights) entry in the first row of column “0”, but will prevent each of the other initiators 110 from accessing the access control matrix 160, based on the “-” (no-rights) entry in each of the other rows of column “0”. In this manner, only InitiatorA is permitted to modify the access rights between initiators 110 and targets 120.

Note that by maintaining and enforcing the access rights information at the bus controller 150, each of the targets 120 are relieved of the responsibility of maintaining and enforcing the access rights. Note also that in the example embodiment of FIG. 1, each initiator is assigned to a specific input port, or interface 116 of the bus controller 150. If the bus controller 150 and the access control matrix 160 are configured to define access rights relative to the input ports, then the identity of an initiator can only be falsified by a physical change to the system, such as the removal of the authorized initiator 110 and a substitution of a bogus initiator at the input port to the bus controller. If the connection between the initiators 110 and the bus controller 150 are “hard-wired”, such as the connection of components to a bus within an integrated circuit, or on a printed circuit board, the security provided by the controller 150 is quite substantial. Because of the complexities associated with modifying the internal circuitry of an integrated circuit, the security level provided by a bus within an integrated circuit is significantly greater than a bus on a printed circuit board. If the connection between the initiators 110 and the bus controller 150 is via a plug-and-socket combination, the substitution is easier, but still requires gaining physical access to the controller 150. As such, the security provided by this invention is virtually unassailable by a remote hacker or a remote virus.

FIG. 3 illustrates an example block diagram of an alternative bus system 300 with access control in accordance with this invention. In this example, each device 320 is connected parallel to each other on the bus. While not involved in a data transfer, each device 320 maintains an ‘inactive’ state on the bus. When a device 320 desires to initiate a data transfer, the device 320 asserts an ‘active’ state on the bus. The active and inactive states are defined such that the active state overrides the inactive states. For example, a logic-high inactive state is common, wherein each device 320 couples the bus to a logic-high value through a relatively high impedance. To assert an active state, a device 320 couples the bus to a logic-low value through a very low impedance. Because the coupling to the logic-low value is via a very low impedance while the coupling to the logic-high value is via one or more high impedance paths, the bus is driven to the logic-low value. Such a configuration is commonly termed a Wired-AND bus configuration, because if any input to the bus is a logic-low value, the state of the bus will be a logic-low value, regardless of the values from the other inputs to the bus, thereby emulating the function of an AND gate. Wired-OR bus configurations are also common, wherein if any input to the bus is at a logic-high value, the bus will be forced to a logic-high value, regardless of the other inputs to the bus, thereby emulating the function of an OR gate.

In this embodiment, an access controller 310 is coupled to the bus to monitor data transfer requests from each of the devices 320 Device1, Device2, . . . DeviceN. Because the configuration of the bus is such that each device 320 is in parallel with each other device 320, there is no explicit distinction between initiators and targets in the structure of the bus. The data transfer request includes the explicit identification of the initiating device, and the intended target device. Optionally, a hybrid embodiment could be used, wherein each initiating device includes an identification signal that is directly wired to the access controller 310 to identify the initiator of each transaction on the bus, thereby providing for the above-mentioned physical security features of this invention.

The access controller 310 determines whether the transfer is authorized, based on an identification of access rights. In this example embodiment, an access control matrix 160, as discussed above, provides the predefined access rights in the form of a matrix wherein both the rows and columns are associated with devices, rather than specific initiators and targets.

If the transfer is not authorized, the access controller 310 asserts one or more active signals onto the bus to prevent the data transfer. For example, if the bus protocol requires a transferring device 320 to provide a clocking signal to effect the transfer, the controller 310 merely asserts a continuous active state on the clock line, thereby preventing any other device 320 from toggling the line. Alternatively, the controller 310 may merely assert a continuous active state on the data lines, thereby preventing any other device 320 from asserting data values corresponding to the inactive state. In a preferred embodiment, the bus protocol includes a “reset” state corresponding to the assertion of a continuous active state for an extended duration. According to this protocol, when any device 320 detects this reset state, the device 320 must terminate any data transfers and release the bus. Optionally, the bus controller 310 can be configured to follow its transfer-blocking operation with an error message to the unauthorized initiator, to avoid having the initiator tying up the bus with continued attempts to effect the unauthorized transfer.

The foregoing merely illustrates the principles of the invention. It will thus be appreciated that those skilled in the art will be able to devise various arrangements which, although not explicitly described or shown herein, embody the principles of the invention and are thus within its spirit and scope. For example, not all initiators and/or targets and/or devices 320 need be explicitly included in the access control matrix 160. The access control matrix 160 could be configured to only include remote initiators or devices, and/or the access control matrix 160 could be configured to only contain sensitive targets. Similarly, each initiator and/or target could be identified as belonging to a specific class, based, for example, on a subset of its address, and the access control matrix 160 may identify access rights based on the class of the initiator and/or the class of the target. In like manner, just as one device may correspond to both an initiator and a target, one device may correspond to multiple initiators and/or multiple targets. That is, a device may have different access permissions based on the particular user, the particular application that the user is using, particular subsystems within the device, and so on. Such alternative access permissions may be effected by implementing multiple entries in the access control matrix, thereby providing for ‘virtual devices’ within a common physical device. For example, an initiator may be encoded using two sets of permissions, one set to represent the initiator when it is in a “user” mode, and another set to represent the initiator when it is in an “administrator” or “kernel” mode. These and other system configuration and optimization features will be evident to one of ordinary skill in the art in view of this disclosure, and are included within the scope of the following claims.

I claim:

1. A bus system comprising:
a bus that facilitates communication of signals among a plurality of devices,
an access control matrix that identifies access rights between one or more initiators and one or more targets of the plurality of devices, and
an access controller, operably coupled to the bus and to the access control matrix, that is configured to:
monitor the bus for a data transfer request from a select initiator of the one or more initiators to a select target of the one or more targets, and
selectively inhibit a data transfer between the select initiator and the select target based on the access rights between the select initiator and the select target.

2. The bus system of claim 1, wherein
the access controller is operably coupled in series between the one or more initiators and the one or more targets.

3. The bus system of claim 2, wherein
each of the one or more initiators are independently coupled to the access controller via an input port of a plurality of input ports of the access controller, and
the access control matrix identifies the access rights between the one or more initiators and the one or more targets based on the input port corresponding to each of the one or more initiators.

4. The bus system of claim 1, wherein
the access controller provides an enabling signal to each of the one or more targets, and selectively inhibits the data transfer between the select initiator and the select target via a control of the enabling signal associated with the select target.

5. The bus system of claim 1, wherein
the access controller is operably coupled in parallel with the one or more initiators and the one or more targets.

6. The bus system of claim 5, wherein
the access controller selectively inhibits the data transfer between the select initiator and the select target by asserting a signal state onto the bus that prevents the select initiator from changing the signal state on the bus.

7. The bus system of claim 1, wherein
the access control matrix is configured to identify the access rights between the one or more initiators and the one or more targets based on at least one of: an initiator classification and a target classification.

8. An electronic system comprising:
a plurality of devices that are configured to communicate signals among each other,
an access control matrix that identifies access rights between pairs of devices of the plurality of devices, and
an access controller, operably coupled to the plurality of devices and to the access control matrix, that is configured to:
receive a data transfer request from a first device of the plurality of devices for effecting a data transfer with a second device of the plurality of devices, and
selectively inhibit the data transfer between the first device and the second device, based on the access rights between the pair of devices corresponding to the first device and the second device.

9. The electronic system of claim 8, wherein
the access controller is operably coupled in series between the first device and the second device.

10. The electronic system of claim 9, wherein
the first device is coupled to the access controller via an input port of a plurality of input ports of the access controller, and
the access control matrix identifies the access rights between the first device and the second device based on the input port corresponding to the first device.

11. The electronic system of claim 8, wherein
the access controller inhibits the data transfer between the first device and the second device via control of an enabling signal associated with the second device.

12. The electronic system of claim 8, wherein
the access controller is operably coupled in parallel with the first device and the second device via a bus that is used to communicate the signals between the first device and the second device.

13. The electronic system of claim 12, wherein
the access controller selectively inhibits the data transfer between the first device and the second device by asserting a signal state onto the bus that prevents the first device from changing the signal state on the bus.

14. The electronic system of claim 8, wherein
the access control matrix is configured to identify the access rights between the pairs of devices based on a classification of one or more of the plurality of devices.

15. The electronic system of claim 8, wherein
the plurality of devices include at least one of: a video processing device, a user-identification device, a security device, a memory device, and a processing device.

16. A method of controlling access to a plurality of targets, including
determining an identification of an initiator that is attempting to access a select target of the plurality of targets,
determining a predefined access right between the initiator and the select target, based on the identification of the initiator, and
selectively inhibiting access to the select target, based on the predefined access right between the initiator and the select target.

17. The method of claim 16, wherein
selectively inhibiting the access to the select target includes controlling an enabling signal of the select target.

18. The method of claim 16, wherein
selectively inhibiting the access to the select target includes asserting a signal state onto a bus that prevents the initiator from changing the signal state on the bus.

19. The method of claim 16, wherein
determining the predefined access right between the initiator and the select target is based on at least one of: a classification associated with the initiator, and a classification associated with the select target.
